(19) United States
(12) Patent Application Publication
(10) Pub. No.: US 2012/0148782 A1
(43) Pub. Date: Jun. 14, 2012

(54) LABEL AND LABEL PRINTER

(75) Inventor: Osamu Watanabe, Shizuoka (JP)

(73) Assignee: TOSHIBA TEC KABUSHIKI KAISHA, Tokyo (JP)

(21) Appl. No.: 13/310,910

(22) Filed: Dec. 5, 2011

(30) Foreign Application Priority Data
Dec. 9, 2010 (JP) 2010-274893

(51) Int. Cl. G09F 3/04; B05C 5/00

(52) U.S. Cl. 428/42.3; 428/43; 118/300

(57) ABSTRACT

According to one embodiment, a label, has a base sheet unit having a first adhesive area adhered to an object, and a separable sheet unit connected with the base sheet unit via a first predetermined cutoff portion having a first incision, wherein the information on the object is printed on the separable sheet unit.

### CROSS-REFERENCE TO RELATED APPLICATION

This application claims priority from prior Japanese Patent Application No. 2010-274893, filed on Dec. 9, 2010, which is incorporated herein by reference.

### FIELD

Embodiments described herein relate generally to a label and a label printer.

### BACKGROUND

At present, in supermarket and other shops, the commodity (object), for example, meat, which is packaged with a piece of plastic film with its main body placed in a plate, can be adhered with a label to display related commodity information. The label, which is issued by a label printer, displays commodity information including the name or the shelf life of the commodity.

The customers of such shops include the ones who take the main body of a purchased labeled commodity out of the commodity and place the main body of the commodity into a plastic bag in the shop and then take the plastic bag home, and the ones who directly take a purchased labeled commodity home and considering the large space occupied by the whole commodity in their refrigerator, take out the main body of the commodity, place the main body of the commodity in a plastic bag and then place the plastic bag in their refrigerator.

However, if the main body of a labeled commodity is taken out and then placed in a plastic bag without a label, the name or the shelf life of the main body of the commodity will be lost.

### DESCRIPTION OF THE DRAWINGS

FIG. 1 is a perspective view illustrating the appearance of the label printer involved in a first embodiment;

FIG. 2 is a longitudinal side view of the printing unit of the label printer involved in the first embodiment in an in-housing state.

FIG. 3 is a top plan view of the label involved in the first embodiment;

FIG. 4 is a bottom view of the label involved in the first embodiment;

FIG. 5 is a diagram illustrating an example of the use of the separable sheet unit of the label involved in the first embodiment;

FIG. 6 is a top plan view of the label involved in the first variation of the first embodiment;

FIG. 7 is a top plan view of the label involved in the second variation of the first embodiment;

FIG. 8 is a bottom view of the label involved in the second variation of the first embodiment;

FIG. 9 is a top plan view of the label involved in the third variation of the first embodiment;

FIG. 10 is a bottom view of the label involved in a second embodiment;

FIG. 11 is a top plan view of the label involved in a third embodiment;

FIG. 12 is a bottom view of the label involved in the third embodiment;

FIG. 13 is a top plan view of the label involved in a fourth embodiment;

FIG. 14 is a side view of the label involved in the fourth embodiment;

FIG. 15 is a top plan view of the label involved in a fifth embodiment;

FIG. 16 is a bottom view of the label involved in a sixth embodiment;

FIG. 17 is a top plan view of the label involved in a seventh the seventh embodiment;

FIG. 18 is a top plan view of the label involved in an eighth embodiment;

FIG. 19 is a top plan view of the label involved in a ninth embodiment;

FIG. 20 is a top plan view of the label involved in a tenth embodiment.

### DETAILED DESCRIPTION

In accordance with one embodiment, a label has: a base sheet unit having a first adhesive area adhered to an object, and a separable sheet unit that is connected with the base sheet unit via a first predetermined cutoff portion having a first incision, wherein the information on the object is printed on the separable sheet unit.

In accordance with another embodiment, a label has: a base sheet unit having, on one side, a first adhesive area adhered to an object, and a separable sheet unit having the information on the object on one side and a second adhesive area on the other side, wherein the second adhesive area is adhesively laminated on the other side of the base sheet unit in a peelable manner.

The label and the label printer involved in embodiments are described below in detail with reference to accompanying drawings. In addition, identical components are used in the following several embodiments. Thus, these identical components are represented with the same identifier to avoid repeated description. Besides, the following embodiments are examples of objects that can serve as commodities.

### The First Embodiment

Embodiment 1 is described first.

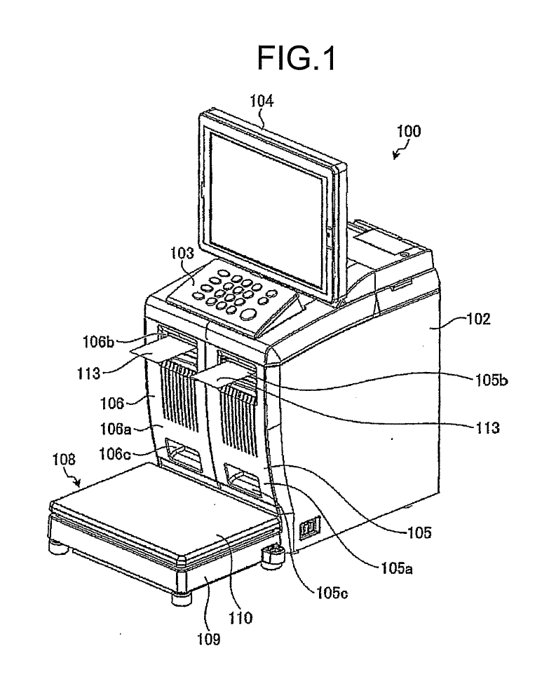

FIG. 1 is a perspective view illustrating the appearance of the label printer involved in the first embodiment. As shown in FIG. 1, a label printer 100 has a housing 102, which is substantially in a rectangular cuboid shape. An operating panel 103 and a display 104 are configured on the housing 102. The operating panel 103 has a keypad and other buttons. The display 104 is a display unit with a liquid crystal display. An opening unit is arranged on the front side of the housing 102. Two parallel printing units 105 and 106 are accommodated in the housing 102.

Front panels 105a and 106a are respectively arranged on the front sides of the printing units 105 and 106. Label issuing openings 105b and 106b are arranged on the upper portions of the front panels 105a and 106a. Holding units 105c and 106c are arranged on the lower portions of the front panels 105a and 106a. In addition, each of the printing units 105 and 106 can be pulled out from the front side of the housing 102 and supported by and putted in the housing 102 in an accommodated manner. The operator can hold the holding units 105c and 106c to pull the printing units 105 and 106 out of the housing 102.

In FIG. 1, a calculator 108 is arranged next to the front side of the label printer 100. The calculator 108 has a flat main body device 109 and a calculating holder 110. The calculating holder 110 is arranged on the main body device 109. The main body device 109 calculates the weight of the object placed on the calculating holder 110 and has a function of outputting calculation data as a calculation result. The label printer 100 is electrically connected with the calculator 108. The calculation data output from the calculator 108 is input to the label printer 100.

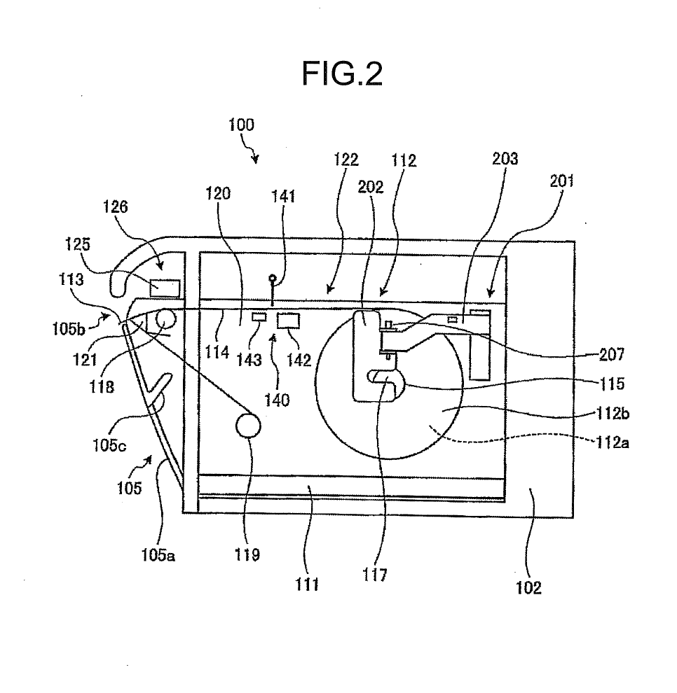

FIG. 2 is a longitudinal side view of the printing unit of the label printer involved in the first embodiment in an in-housing state. In FIG. 2, there is shown the printing unit 105 of the two printing units 105 and 106 which is located on the right side when viewed from the front side of the label printer 100. The printing unit 106 is bilaterally symmetrical to the printing unit 105 shown in FIG. 2 in structure. The description on the printing unit 105 on the right side is given below, while that on the printing unit 106 on the left right is saved.

In this embodiment, the label paper 112 used by the printing unit 105 is roll paper that is rolled into a roller shape. The label paper 112 is formed by adhering a plurality of labels 113 on a slender backing paper 114 in columns and winding the backing paper into a roller shape on a paper core 115. The label 113 uses a thermally sensitive label which serves as the main body of the label 113 and produces a color by heating the paper.

A pair of tracks 111 is designed on the lower inner portion of the housing 102. The tracks 111 extend horizontally towards the inside of the housing 102 from the opening portion on the front side of the housing 102 and support the printing unit 105 freely. Therefore, the operator can pull out the holding unit 105c of the printing unit 105 to enable the printing unit 105 to slide towards the front side of the housing along the tracks 111 so that the printing unit 105 in an in-housing 102 state (as shown in FIG. 2) can be converted to an outside-housing 102 (not shown) state. In addition, the operator can further hold the holding unit 105c to enable the printing unit 105 to slide towards the inside of the housing along the track 111 so that the printing unit 105 in an outside-housing state can be converted to an in-housing state (as shown in FIG. 2).

The printing unit 105 has a paper holding shaft 117, a platen 118, a backing paper rolling shaft 119 and a side wall 120. The paper holding shaft 117 enables the insertion of the label paper 112 into the paper core 115 and holds the label paper 112. The backing paper rolling shaft 119 rolls the backing paper 114 with the label paper 112. The paper holding shaft 117, the platen 118 and the backing paper rolling shaft 119 all protrude from the side wall 120 and are all kept open-side. With the paper holding shaft 117, the platen 118 and a label peeling unit 121 that will be described later, the backing paper rolling shaft 119 forms a guide path 122 for the label paper 112 on the printing unit 105. The guide path 122 starts from the paper holding shaft 117 and ends at the backing paper rolling shaft 119.

The printing unit 105 has a label peeling unit 121, which is located at a downstream side of the guide path 122 in an impressing plate conveying direction and is arranged next to the label issuing opening 105b. The label peeling unit 121 is composed of a V-shaped component. During the conveying process of the backing paper 114, the label peeling unit 121 peels a printed label 113 off the backing paper 114 by upward curving the backing paper 114 into an acute angle in a label-separated direction. Specifically, the label peeling unit 121 peels the label 113 off the backing paper 114 by curving the second side (the back side) of the backing paper 114 into an acute angle, wherein the second side is opposite to the first side of the backing paper 114 adhered with the label 113. Moreover, the label 113 peeled off from the backing paper 114 is issued from the label issuing opening 105b. The label-peeled backing paper 114 is rolled by the backing paper rolling shaft 119. In addition, although the label-peeled backing paper 114 is rolled by the backing paper rolling shaft 119 in this embodiment, it should be appreciated that the label-peeled backing paper 114 may be output to the outside of the label printer 100, instead of being rolled.

As described above, the paper holding shaft 117 is horizontally kept open-side on the side wall 120 of the printing unit 105. The paper holding shaft 117 holds the label paper 112 by inserting the label paper 112 in the paper core 115 for the label paper 112. That is, the side wall 120 serves as a reference surface. The reference surface (the side wall 120) positions a first end surface 112a which serves as one end surface of the label surface 112. In addition, the paper holding shaft 117 serves as a paper holding unit. The paper holding unit (the paper holding shaft 117) takes the side wall 120 serving as a reference surface as a reference to rotationally maintain the label paper 112 rolled into a roller shape.

A second end surface 112b which do not turn on the side wall 120 (the depth side shown in FIG. 2), turn on the opposite side thereof (this side shown FIG. 2), of the label paper 112 that is inserted in the paper core 115 and held by the paper holding shaft 117, biased by the rotating component 202 and pressed into the width-direction of the label paper 112 (the axis direction of the paper holding shaft 117). The rotating component 202 is an interferer body. On the other hand, the first end surface 112a of the label paper 112 is propped against the side wall 120 serving as a reference surface. In this way, by sandwiching the label paper (roll paper) 112 between the side wall 120 and the rotating component 202, the movement of the label paper in its width direction 112 can be limited when being pulled out along the guide path 122.

The rotating component 202 is rotationally mounted on the front end of an arm main body 203 by the rotating component with a rotating shaft 207. The arm main body 203 constitutes one part of a roll paper holding mechanism 201. The rotating component 202 causes interference on the second end surface 112b of the label paper 112 through the rotation of the arm main body 203. The rotating component 202 is rotationally displaced by causing interference on the second end surface 112b of the label paper 112.

The platen 118 is located below the guide path 122. The platen 118 is rotated via a gear column (not shown) under the drive of a platen motor (not shown). The rotating platen 118 endows the label paper 112 on the guide path 122 with a conveying force to pull the label paper 112 held on the paper holding shaft 117 out along the guide path 122. The imprinting platen 118, the imprinting plate motor and the gear column serve as a conveyor unit, which pulls out the label paper 112 and conveys the label paper 112 along the guide path 122.

The backing paper rolling shaft 119 receives a driving forth from a rolling motor (not shown) via a gear column (not shown) on the back side of the side wall 120 to rotate. The rotating backing paper rolling shaft 119 only rolls the backing paper 114 in the label paper 112 passing the label peeling unit 121. The label peeling unit 121 and the rotating backing paper rolling shaft 119 are respectively positioned at locations where the backing paper rolling shaft 119 rolls the backing paper 114 and where the backing paper 114 is curved into an acute angle at the label peeling unit 121.

A thermally sensitive head 125 is arranged on the inner upper portion of the housing 102. The thermally sensitive head 125 is a linear thermally sensitive printing head. The thermally sensitive head 125 is installed at a position opposite to the platen 118 when the printing unit 105 is accommodated in the housing 102. The thermally sensitive head 125 constitutes the printing part 126 of the platen 118.

In addition, the printing unit 105 is provided with a cutter 140. The cutter 140 is located between the paper holding shaft 117 and the platen 118 in the guide path 122. The cutter 140 has a movable blade 141, a fixed blade 142 and a paper supporter 143. The movable blade 141 and the fixed blade 142 are located at the position of the guide path 122 therebetween. The movable blade 141 has a saw-shaped point. Under the drive of a driving motor (not shown), the movable blade 141 reciprocates linearly with respect to the fixed blade. The cutter 140 can support the backside of the label paper 113 with the paper supporter 143. The cutter 140 drives the movable blade 141 so as to form perforation incisions on the label 113 by means of the movable blade 141 and the fixed blade 142. In this case, the movable blade 141 is driven to implement an incomplete cutoff on the label 113. Specifically, the movable blade 141 is driven from the initial position to the position where performations are formed on the label 113 by the saw-shaped blade point and then driven back to the initial position.

Further, the label printer 100 has a controller unit (not shown). The controller unit drives and controls each component of the label printer 100. The controller unit is a computer provided with a CPU or RAM, an ROM and a communication interface.

The label printer 100 with the above-described components conveys the label paper 113 while pulling out the label paper 113 with a platen 118. When conveying the label 113, the label printer 100 forms incisions on the label 113 with the cutter 140. Besides, the label printer 100 prints letters with the thermally sensitive head 125. Moreover, the label printer 100 issues, from the label issuing opening 105b, the label 113 that is peeled off from the backing paper 114 with the label peeling unit 121.

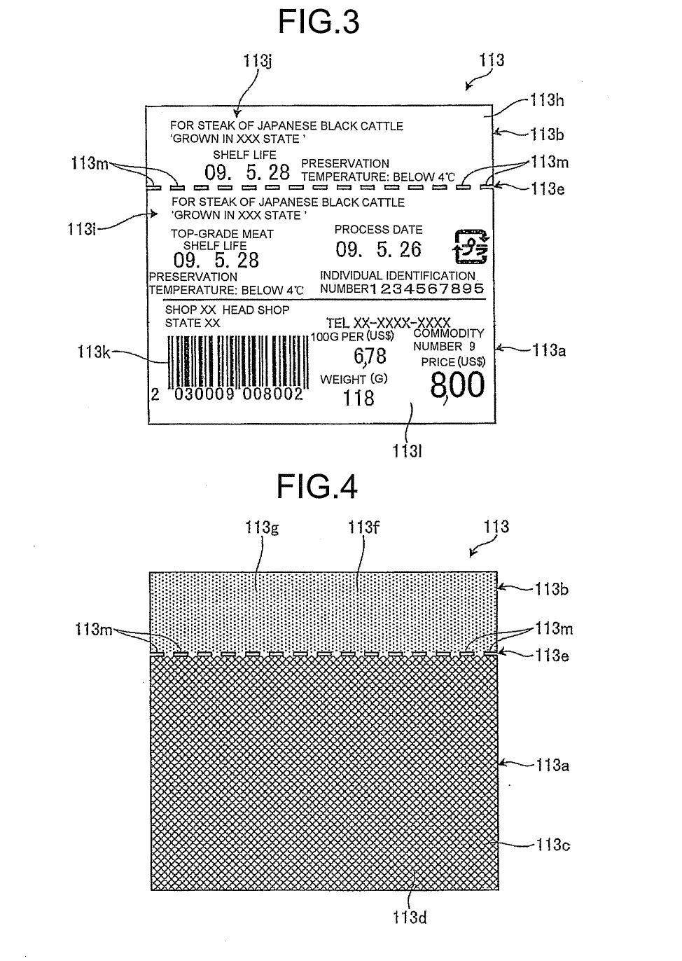

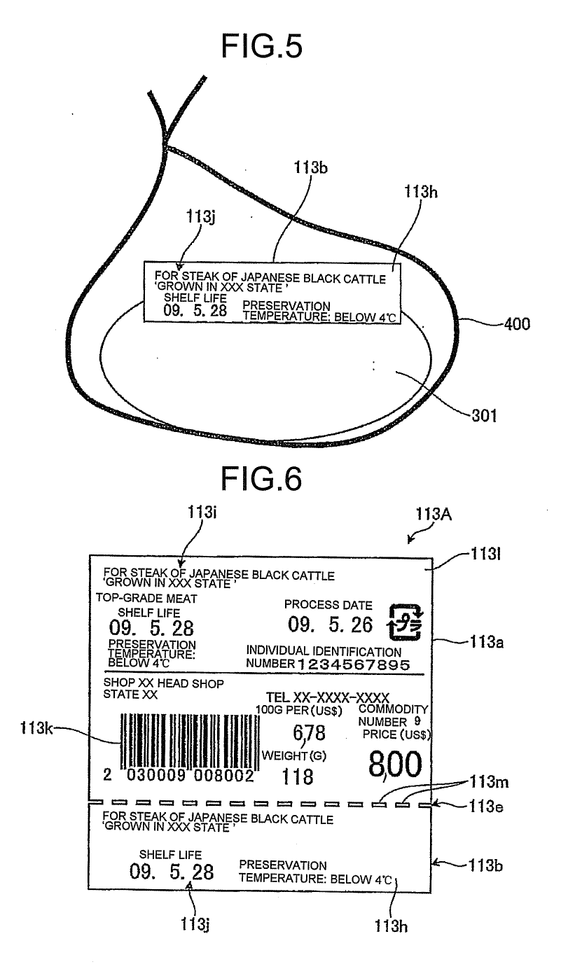

The label 113 issued by the label printer 100 is described below. FIG. 3 is a top plan view of the label involved in this embodiment. FIG. 4 is a bottom view of the label involved in this embodiment. FIG. 5 is a diagram illustrating an example of the use of the separable sheet unit of the label involved in this embodiment.

As shown in FIG. 3 and FIG. 4, the label 113 has a base sheet unit 113a and a separable sheet unit 113b. The label 113 has an adhesive area on one side (the back side). Commodity information is printed on the other side (the surface) of the label 113. Moreover, in this embodiment, the separable sheet unit 113b is arranged above the base sheet unit 113a. The commodity information refers to the information on a commodity serving as an object. The commodity information is equivalent to object information.

A first adhesive area 113d with adhesiveness is arranged on one side (the back side) 113c of the base sheet unit 113a. The first adhesive area 113d is adhered to a commodity. The first adhesive area 113d substantially covers the whole side 113c of the base sheet unit 113a.

The separable sheet unit 113b is connected with the base sheet unit 113a via a first predetermined cutoff portion 113e. A second adhesive area 113g with adhesiveness is arranged on one side (the back side) 113f of the separable sheet unit 113b. The side 113f of the separable sheet unit 113b is located on the same side with the side 113c of the base sheet unit 113a. The second adhesive area 113g can be repeatedly adhered to or peeled off from an object. The second adhesive area 113g substantially covers the whole side 113f of the separable sheet unit 113b. The second adhesive area 113g is less adhesive than the first adhesive area 113d. In this way, a plurality of adhesive areas with different adhesive forces are arranged on the label 113 in this embodiment. This construction can be achieved by coating adhesives with different adhesive forces on corresponding areas on one side of the label 113 during the production process of the label 113.

Commodity information 113i and commodity information 113j are respectively printed on the other sides (the surfaces) 113i and 113h of the base sheet unit 113a and the separable sheet unit 113b. The commodity information 113i and the commodity information 113j include the name, the shelf life and the production place of the commodity. The shelf life is the service life related to the quality of the commodity. In accompanying drawings, for example, ‘for steak of Japanese black cattle’ is the name of commodity, ‘09. 5. 28’ which shows May 28, 2009 is the shelf life of commodity. The commodity information 113i printed on the base sheet unit 113a further includes price information. In addition, barcodes 113k serving as a barcode mark are printed on the base sheet unit 113a. Further, the commodity information 113j printed on the separable sheet unit 113b may include at least one of the service life related to the quality of the commodity and the name of the commodity. Further, the service life related to the quality of the commodity is not limited to the shelf life and may further be a freshness period.

A plurality of first incisions 113m are formed on the first predetermined cutoff portion 113e. The first incisions 113m are spaced from each other and arranged into a column. The first incisions 113m are arranged at equal intervals. That is, the first incisions 113m are formed in a perforation form on the first predetermined cutoff portion 113e. The first predetermined cutoff portion 113e constitutes a border between the base sheet unit 113a and the separable sheet unit 113b. The first predetermined cutoff portion 113e can be cut off.

The label with the above-described structure is adhered to a commodity by an operator in, for example, a shop. The commodity refers to a commodity packaged with a piece of plastic film (not shown) with its main body 301 (serving as an object main body) placed in a plate (not shown), wherein in this embodiment, the main body 301 of the commodity refers to meat (referring to FIG. 5). In this case, the operator pastes the first adhesive area 113d of the base sheet unit 113a onto the commodity. The second adhesive area 113g of the separable sheet unit 113b can be adhered to the commodity or not. In this way, by cutting off the first predetermined cutoff portion 113e, the separable sheet unit 113b of the label 113 adhered to the commodity can be separated from the base sheet unit 113a. In the label 113 described in this embodiment, the second adhesive area 113g is less adhesive than the base sheet unit 113a. Thus, even if the second adhesive area 113g of the separable sheet unit 113b is adhered to the commodity, the separable sheet unit 113b of the label 113 described in this embodiment can be peeled from the commodity more easily than that of the label in which the second adhesive area 113g is as adhesive as or more adhesive than the base sheet unit 113a. Therefore, the separable sheet unit 113b on the commodity can be separated from the base sheet unit 113a. The customer can take the main body 301 (FIG. 5) of the commodity out of the purchased labeled commodity and paste the separable sheet unit 113b onto a plastic bag 400 containing the main body 301 of the commodity.

As discussed above, the label 113 involved in this embodiment has a base sheet unit 113a and a separable sheet unit 113b. The base sheet unit 113a has a first adhesive area that is adhered to a commodity. Commodity information 113j is printed on the separable sheet unit 113b. The separable sheet unit 113b is connected with the base sheet unit 113a via the first predetermined cutoff portion 113e. A plurality of first incisions 113m are formed on the first predetermined cutoff portion 113e. Thus, the separable sheet unit 113b separated from the base sheet unit 113a can be adhered to a container (referring here to a plastic bag 400) in which the main body 301 of a commodity is contained. In this way, the label involved in this embodiment eliminates the problem that the name or shelf time of a commodity main body 301 placed in another container such as a plastic bag 400 may be lost.

The label involved in a variation of this embodiment is described below.

FIG. 6 is a top plan view of the label involved in the first variation of the first embodiment. The label 113A involved in the first variation embodiment is different from the label 113 in the location of the separable sheet unit 113b, which is below the base sheet unit 113a.

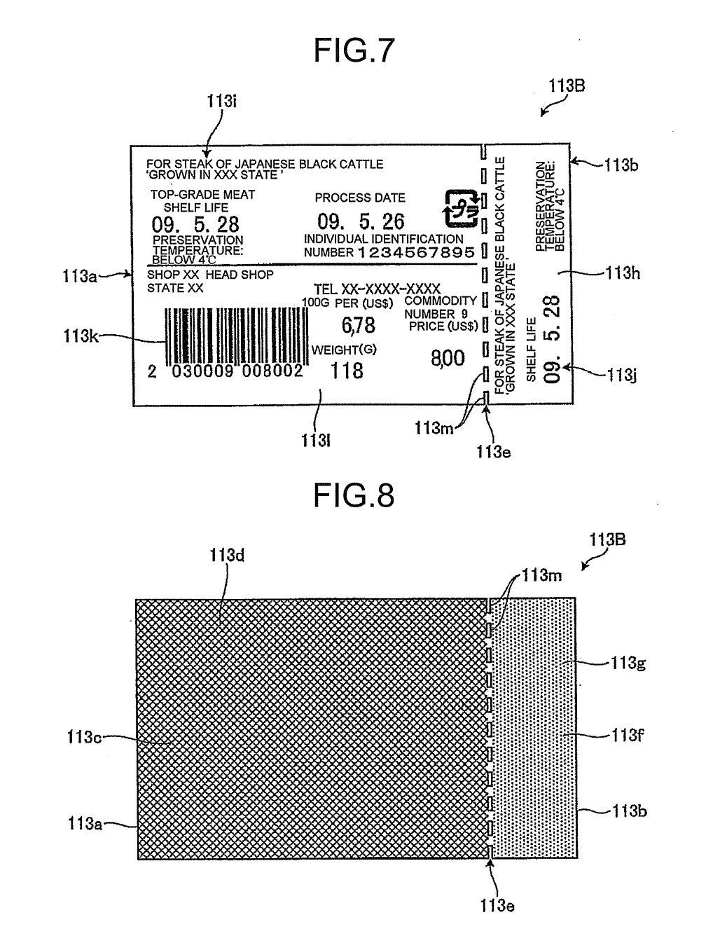

FIG. 7 is a top plan view of the label involved in the second variation of the first embodiment. FIG. 8 is a bottom view of the label involved in the second variation of the first embodiment. The label 113B involved in the second variation embodiment is different from the label 113 in the location of the separable sheet unit 113b, which is on the same side with the base sheet unit 113a. In addition, in the second variation embodiment, the direction of the information text shown in the separable sheet unit 113b is vertical to that of the information text shown in the base sheet unit 113a.

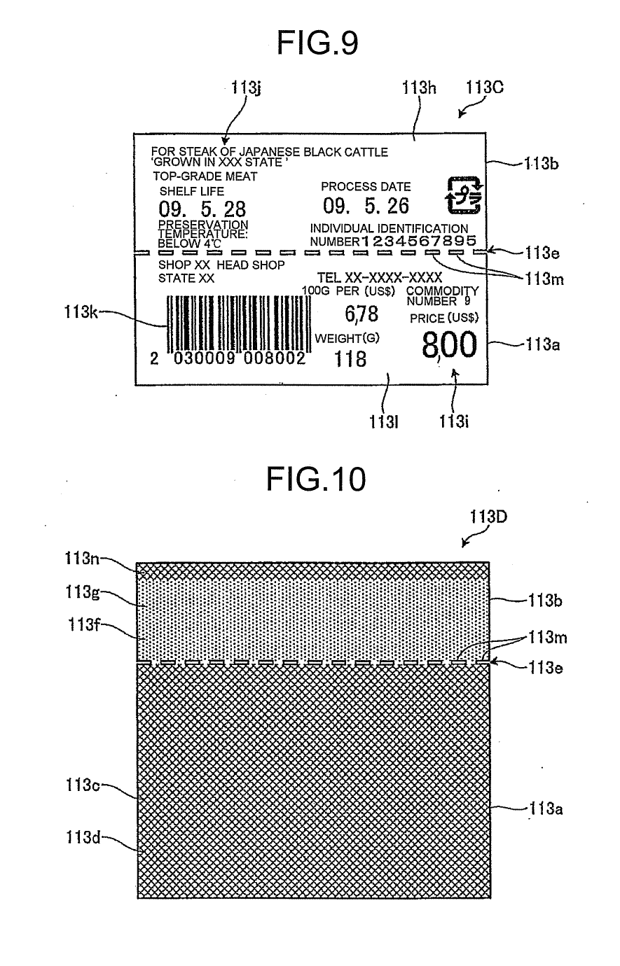

FIG. 9 is a top plan view of the label involved in the third variation of the first embodiment. In the label 11C involved in the third variation embodiment, the name and the shelf life of a commodity are printed on the separable sheet unit 113b but not on the base sheet unit 113a.

Even in the labels 113A, 113B and 113C involved in the first, second and third variation embodiments above, the separable sheet unit 113b can be separated from the base sheet unit 113a. Thus, like the label 113, the labels 113A, 113B and 113C each eliminate the problem that the name or shelf time of a commodity main body 301 placed in another container such as a plastic bag 400 may be lost.

### The Second Embodiment

Then, the second embodiment is described below.

FIG. 10 is a bottom view of the label involved in this embodiment. As shown in FIG. 10, the label 113D involved in this embodiment is different from the label 113 in the separable sheet unit 113b, which has a third adhesive area 113n on one side 113f. The third adhesive area 113n is more adhesive than the second adhesive area 113g but as adhesive as the first adhesive area 113d in the base sheet unit 113a.

One side (the back side) of the label 113D can be wholly adhered to a commodity. As the third adhesive area 113n is more adhesive than the second adhesive area 113g, the separable sheet unit 113b can be firmly adhered to a commodity.

Even in the label 113D involved in the above-described embodiment, the separable sheet unit 113b can be separated from the base sheet unit 113a. Thus, like the label 113, the label 113D eliminates the problem that the name or shelf time of a commodity main body 301 placed in another container such as a plastic bag 400 may be lost.

### The Third Embodiment

Then, the third embodiment is described below.

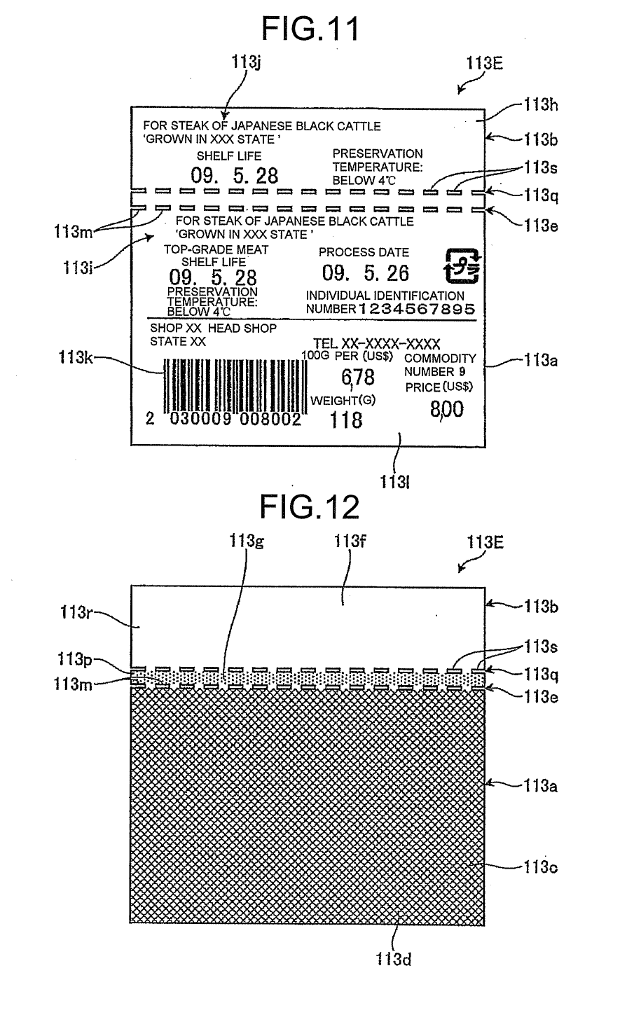

FIG. 11 is a top plan view of the label involved in this embodiment. FIG. 12 is a bottom view of the label involved in this embodiment. As shown in FIG. 11 and FIG. 12, the label 113E involved in this embodiment is different from the label involved in the first embodiment in the separable sheet unit 113b, which has a first sheet portion 113p and a non-adhesive second sheet portion 113r. The first sheet portion 113p has the second adhesive area 113g.

The first sheet portion 113p is connected with the base sheet unit 113a via the first predetermined cutoff portion 113e.

The second sheet portion 113r without any adhesive area is connected with the first sheet portion 113p via a second predetermined cutoff portion 113q.

A plurality of second incisions 113s are formed on the second predetermined cutoff portion 113q. The second incisions 113s are spaced from each other and arranged into a column. That is, the second incisions 113s are arranged on the second predetermined cutoff portion 113q in a perforation form. Thus, the second predetermined cutoff portion 113q constitutes a border between the first sheet portion 113p and the second sheet portion 113r. Besides, the second predetermined cutoff portion 113q can be cut off.

Even in the above-described label 113E, the first predetermined cutoff portion 113e can be cut off, and the separable sheet unit 113b can be separated from the base sheet unit 113a. In this case, the separable sheet unit 113b separated from the base sheet unit 113a has a second adhesive area 113g. Thus, the separable sheet unit 113b can be adhered to a plastic bag 400 via the second adhesive area 113g. In addition, in the label 113E, the second predetermined cutoff portion 113q can be cut off, and only the second sheet portion 113r of the separable sheet unit 113b is separated from the base sheet unit 113a. In this case, the second sheet portion 113r of the separable sheet unit 113b separated from the base sheet unit 113a has no adhesive area. As a consequence, the sheet portion 113r can be easily inserted into the label insertion unit of a container.

Even in the label 113E involved in the above-described embodiment, the separable sheet unit 113b can be separated from the base sheet unit 113a. Thus, like the label 113, the label 113E eliminates the problem that the name or shelf time of a commodity main body 301 placed in another container such as a plastic bag 400 may be lost.

### The Fourth Embodiment

Then, the fourth embodiment is described below.

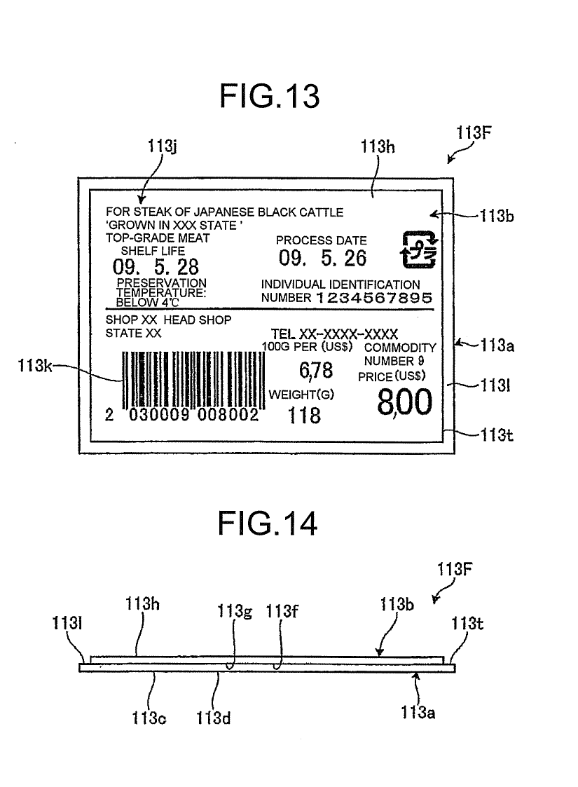

FIG. 13 is a top plan view of the label involved in this embodiment. FIG. 14 is a bottom view of the label involved in this embodiment. As shown in FIG. 13 and FIG. 14, the label 113F involved in this embodiment is different from that involved in the first embodiment in the separable sheet unit 113b, which is laminated on the base sheet unit 113a.

A first adhesive area 113d, which is adhered to a commodity, is arranged on one side (the back side) 113c of the base sheet unit 113a, on which no commodity information is printed.

Commodity information 113j is printed on one side (the surface) of the separable sheet unit 113b. Further, barcodes 113k are printed on one side of the separable sheet unit 113b. A second adhesive area 113g is arranged on one side 113f of the separable sheet unit 113b. The second adhesive area 113g is adhered to the other side (the surface) 113i of the base sheet unit 113a. The separable sheet unit 113b is adhesively laminated on the other side 113i of the base sheet unit 113a in a peelable manner. In this embodiment, the line 113t formed between the separable sheet unit 113b and the base sheet unit 113a constitutes a border for these two units.

In the label 113F with the structure above, the separable sheet unit 113b peeled off from the base sheet unit 113a can be adhered to a plastic bag 400.

Even in the above-described label 113F involved in this embodiment, the separable sheet unit 113b can be separated from the base sheet unit 113a. Thus, like the label 113, the label 113F eliminates the problem that the name or shelf time of a commodity main body 301 placed in another container such as a plastic bag 400 may be lost.

### The Fifth Embodiment

Then, the fifth embodiment is described below.

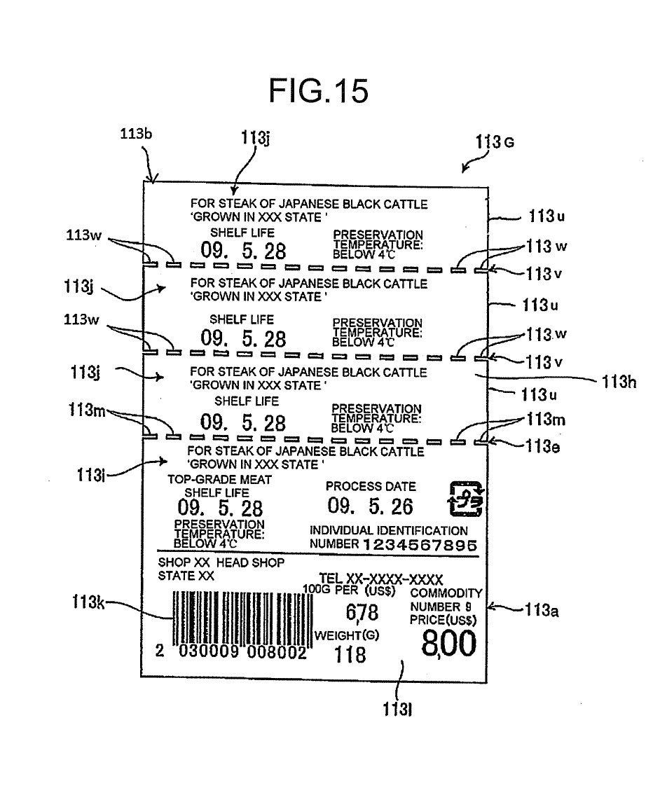

FIG. 15 is a top plan view of the label involved in the fifth embodiment. As shown in FIG. 15, the label 113G involved in this embodiment is different from that involved in the first embodiment in the separable sheet unit 113b.

In this embodiment, the separable sheet unit 113b has a plurality of fourth sheet portions 113u. As an example of this embodiment, there are three fourth sheet portions 113u. The commodity information 113j serving as object information is printed on each fourth sheet portion 113u.

The fourth sheet portions 113u are connected with each other via a third predetermined cutoff portion 113v. A plurality of third incisions 113w are formed on the third predetermined cutoff portion 113u. The third incisions 113w are spaced from each other and arranged into a column. That is, the third incisions 113w with perforations are arranged on the third predetermined cutoff portion 113u. In this way, the third predetermined cutoff portion 113u shows a border for the adjacent fourth sheet portion 113u. Besides, the third predetermined cutoff portion 113u can be cut off.

### The Sixth Embodiment

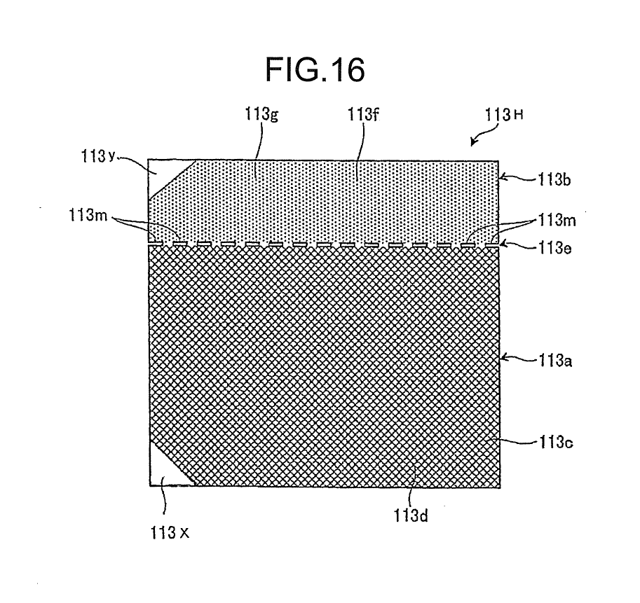

Then, the sixth embodiment is described below. FIG. 16 is a bottom view of the label involved in the sixth embodiment. As shown in FIG. 16, the label 113H involved in this embodiment is different from that involved in the first embodiment in the separable sheet unit 1133b.

The base sheet unit 113a has a first adhesive area 113d and a non-adhesive area 113x on one side 113c. Besides, the separable sheet unit 113b has a second adhesive area 113g and a non-adhesive area 113y on one side 113f. That is, one part of the side 113c of the base sheet unit 113a constitutes the non-adhesive area 113x, and one part of the side 113f of the separable sheet unit 113b constitutes the non-adhesive area 113y.

### The Seventh Embodiment

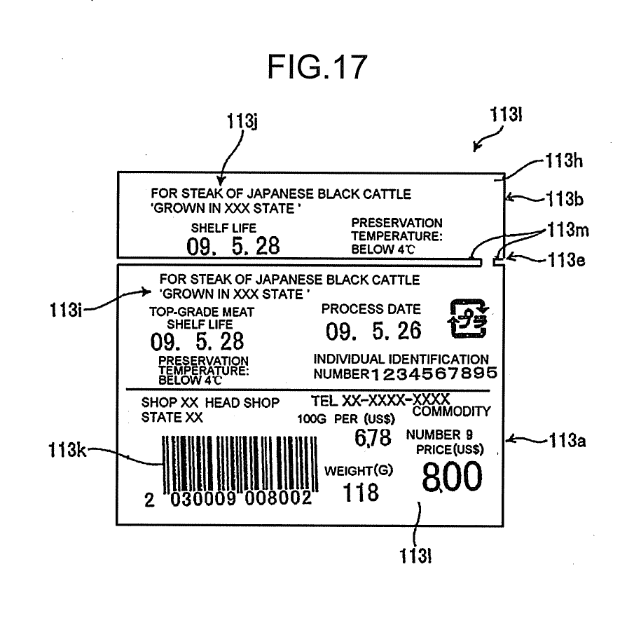

Then, the seventh embodiment is described below. FIG. 17 is a top plan view of the label involved in the seventh embodiment. As shown in FIG. 17, the label 113I involved in this embodiment is different from that involved in the first embodiment in the first predetermined portion 113e, on which a plurality of first incisions 113m are non-uniformly formed. As an example, two first incisions 113m with different lengths are formed in this embodiment.

### The Eighth Embodiment

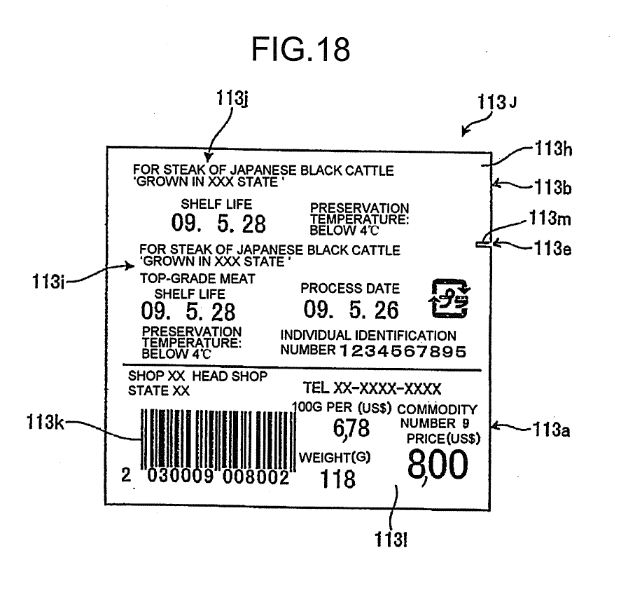

Then, the eighth embodiment is described below. FIG. 18 is a top plan view of the label involved in the eighth embodiment. As shown in FIG. 18, the label 113I involved in this embodiment is different from that involved in the first embodiment in the first predetermined portion 113e, on which only one first incision 113m is formed. As an example, only one incision 113m is formed on one end of the first predetermined portion 113e in this embodiment.

### The Ninth Embodiment

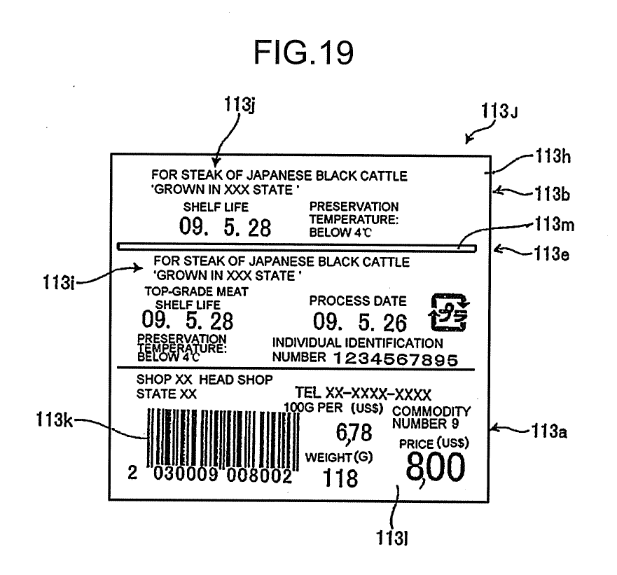

Then, the ninth embodiment is described below. FIG. 19 is a top plan view of the label involved in the ninth embodiment. As shown in FIG. 19, the label 113J involved in this embodiment is different from that involved in the first embodiment in the first predetermined portion 113e, on which only one first incision 113m is formed. In this embodiment, as an example, a first incision 113m is formed between two ends (in the width direction) of the first predetermined portion 113e. That is, the first predetermined cutoff portion 113e connects the two ends (in the width direction) of the base sheet unit 113a with two ends (in the width direction) of the separable sheet unit 113b.

### The Tenth Embodiment

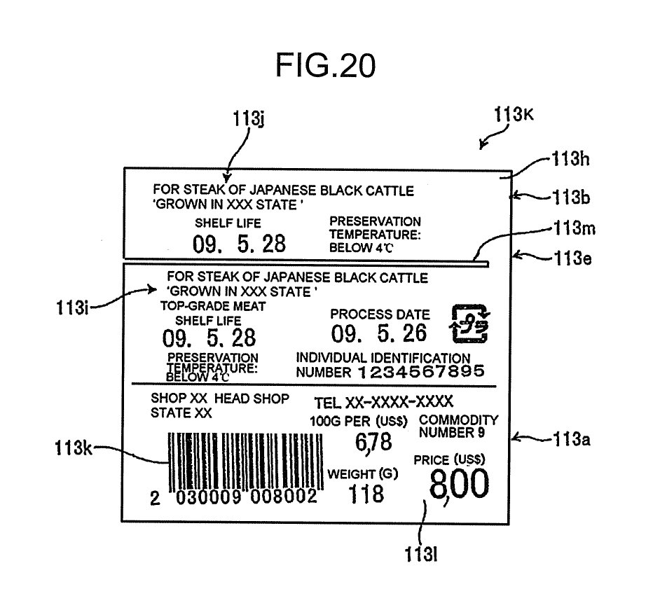

Then, the tenth embodiment is described below. FIG. 20 is a top plan view of the label involved in the first embodiment. As shown in FIG. 20, the label 113K involved in this embodiment is different from that involved in the first embodiment in the first predetermined portion 113e, on which only one first incision 113m is formed. Moreover, in this embodiment, the first predetermined portion 113e only connects one end (in the width direction) of the base sheet unit 113a with one end (in the width direction) of the separable sheet unit 113b.

In addition, the present invention is not limited to the above-described embodiments, and various other embodiments can be devised without departing from the scope of the present invention.

For instance, in the labels 113, 113A-113E and 113G-113K described in embodiments 1-3, the separable sheet unit 113b may have a non-adhesive area but not an adhesive area (the second adhesive area 113g, the third adhesive area 113n). In this case, the customer can paste the separable sheet unit 113b separated from the base sheet unit 113a onto a container such as a plastic bag 400 with an adhesive tape and the like.

In addition, the object is not limited to commodity and may be other goods.

As described above, the labels 113 and 113A-113K involved in the embodiments above and the label printer 100 eliminate the problem that the name or shelf time of a commodity main body 301 placed in another container such as a plastic bag 400 may be lost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label, comprising:
a base sheet unit having a first adhesive area adhered to an object; and
a separable sheet unit that is connected with the base sheet unit via a first predetermined cutoff portion having a first incision, wherein the information on the object is printed on the separable sheet unit.

2. The label according to claim 1, wherein
the first adhesive area is on the area of one side of the base sheet unit;
a second adhesive area less adhesive than the first adhesive area of the separable sheet unit is on the area of the side which is the same side of one side of the base sheet unit.

3. The label according to claim 2, wherein
a third adhesive area more adhesive than the second adhesive area is on the side of the separable sheet unit on the same side with one side of the base sheet unit.

4. The label according to claim 2, wherein
the separable sheet unit having a first sheet portion that is provided with the second adhesive area and connected with the base sheet unit via the first predetermined cutoff portion and a second non-adhesive sheet portion that is connected with the first sheet portion via a second predetermined cutoff portion with a second incision.

5. A label, comprising:
a base sheet unit having a first adhesive area adhered to an object; and
a separable sheet unit, one side of which is used for displaying the information on the object, and the other side of which has a second adhesive area that is adhesively laminated on the other side of the base sheet unit in a peelable manner.

6. The label according to claim 1, wherein
the object information includes the name and the shelf life of the object.

7. The label according to claim 1, wherein
the separable sheet unit has a plurality of fourth sheet portions that are connected with each other via a third predetermined cutoff portion having a third incision; and
the object information is printed on each of the fourth sheet portions.

8. The label according to claim 1, wherein
the object information printed on the separable sheet unit is not printed on the base sheet unit.

9. The label according to claim 1, wherein
one side of the base sheet unit is provided with the first adhesive area and a non-adhesive area.

10. The label according to claim 2, wherein
a non-adhesive area is on the side of the separable sheet unit on the same side with one side of the base sheet unit.

11. The label according to claim 1, wherein
a plurality of first incisions are arranged on the first predetermined cutoff portion at equal intervals.

12. The label according to claim 1, wherein
a plurality of first incisions are non-uniformly arranged on the first predetermined.

13. The label according to claim 1, wherein
only one first incision is arranged on the first predetermined cutoff portion.

14. The label according to claim 13, wherein
the first incision is arranged on one end of the first predetermined cutoff portion.

15. The label according to claim 13, wherein
the first incision is arranged between two ends of the first predetermined cutoff portion.

16. The label according to claim 13, wherein
the first incision and the first predetermined cutoff portion only connect one end of the base sheet unit and one end of the separable sheet unit.

17. A label printer for issuing the label of claim 1.
